(19) United States
(12) Patent Application Publication
(10) Pub. No.: US 2011/0278882 A1
(43) Pub. Date: Nov. 17, 2011

(54) GUIDE MEMBER

(75) Inventor: Josh David Fraley, South Lyon, MI (US)

(73) Assignee: Toyota Motor Engineering & Manufacturing North America, Inc., Erlanger, KY (US)

(21) Appl. No.: 12/778,495

(22) Filed: May 12, 2010

(51) Int. Cl. B60J 7/057; B60J 7/04

(52) U.S. Cl. 296/223; 296/216.08

(57) ABSTRACT

A guide member for a generally flexible and elongated drive element having a free end that passes through the guide member is disclosed. The guide member can have a plurality of alternating half-tube sections that extend along a desired drive element path. At least one of the plurality of alternating half-tube sections can have a funnel-shaped end that expands an entrance of the half-tube section and is operable to guide the free end of the drive element back along the desired drive element path in the event that the free end of the drive element deviates from the desired drive element path before entering the half-tube section having the funnel-shaped end.

### FIELD OF THE INVENTION

The present invention relates to a guide member for a generally flexible and elongated drive element, and in particular to a guide member having a plurality of alternating half-tube sections extending along a desired drive element path.

### BACKGROUND OF THE INVENTION

The use of a flexible and elongated drive element such as a cable, belt, chain, etc., to move, open and/or close a component is known. In some instances, the cable, belt, chain, etc., travels within a guide member or guide structure such as a rail, tube, and the like. In addition, a drive system for moving, opening and/or closing the component can use the cable, belt, chain, etc., to push and/or pull on the component.

In some instances, the cable, belt, chain, etc., can have a free end that travels within the guide member. In the event that the guide member does not completely enclose the cable, belt, chain, etc., there is the possibility that the free end of the drive element can escape from the guide member and travel outside thereof and improper operation of the drive system can occur. Such a guide element can include a plurality of half-tube sections that extend along a desired drive element path as illustrated in FIGS. 2 and 3 which show a guide member 130 with a drive element 110 having a free end 116 that has escaped therefrom. It is appreciated that such a result as illustrated in FIG. 2 can occur when the guide member 130 has a curvature along the desired drive element path and/or the drive element 110 has an eccentricity along its length. As such, an improved guide member that retards and/or prevents a drive element from escaping therefrom would be desirable.

### SUMMARY OF THE INVENTION

A guide member for a generally flexible and elongated drive element having a free end that passes through the guide member is disclosed. The guide member can have a plurality of alternating half-tube sections that extend along a desired drive element path. At least one of the plurality of alternating half-tube sections can have a funnel-shaped end which expands an entrance to the half-tube section for an approaching free end of the drive element. In this manner, the funnel-shaped end can guide the free end of the drive element back along the desired drive element path in the event that the free end of the drive element deviates from the desired drive element path before entering the half-tube section having the funnel-shaped end.

The plurality of alternating half-tube sections, the drive element and a motor operable to push and/or pull on the drive element can be part of a drive system and the drive system can be part of a sunroof for a vehicle. In addition, the drive element can be a cable, a belt, a chain, etc., and the plurality of alternating half-tube sections can be generally rigid and may or may not be a unitary component.

### BRIEF DESCRIPTION OF THE DRAWINGS

FIG. 1 is a perspective view of a sunroof for a motor vehicle;

FIG. 2 is a perspective view of a prior art guide member;

FIG. 3 is a cross-sectional view of section 3-3 shown in FIG. 2;

FIG. 4 is a perspective view of a guide member according to an embodiment of the present invention;

FIG. 5 is a cross-sectional view of section 5-5 shown in FIG. 4;

FIG. 6 is a cross-sectional view of a guide member according to another embodiment of the present invention; and

FIG. 7 is a cross-sectional view of a guide member according to yet another embodiment of the present invention.

### DETAILED DESCRIPTION OF THE INVENTION

The present invention discloses a guide member for a generally flexible and elongated drive element that has a free end that can pass through the guide member. As such, the present invention has utility as a component for a machine such as a motor vehicle.

The guide member can include a plurality of alternating half-tube sections that extend along a desired drive element path. It is appreciated that the desired drive element path is a path that the elongated drive element follows when it passes through the alternating half-tube sections. The plurality of alternating half-tube sections can provide a tube-like structure having spaced apart openings that afford for the drive element can pass therethrough and still be produced using molding techniques such as injection molding. In addition, the guide member with the plurality of alternating half-tube sections can be generally rigid and may or may not be part of a unitary component. Stated differently, the plurality of alternating half-tube sections can be integral with each other and/or be part of a single molded component.

At least one of the plurality of alternating half-tube sections can have a funnel-shaped end that affords for an expanded entrance of the half-tube section that can guide the free end of the drive element back along the desired drive element path in the event that the free end deviates from the desired drive element path before entering the half-tube section with the funnel-shaped end. In this manner, the free end of the flexible and elongated drive element can be prevented from escaping the guide member.

In some instances, the guide member can have a drive tube portion and a return tube portion. The drive tube portion can be associated with a portion of the drive element that is pushed therethrough in order to push upon a component and afford for its movement, opening and/or closing. The return tube portion can be associated with a portion of the drive element that is not pushed upon in order to move, open and/or close the component. It is appreciated that the free end of the drive element can travel along at least a part of the return tube portion, and as such, the return tube portion can have the at least one alternating half-tube section with the funnel-shaped end. It is further appreciated that a motor can be used to push and/or pull the drive element and that the plurality of alternating half-tube sections, the drive element, and the motor can be part of a drive system.

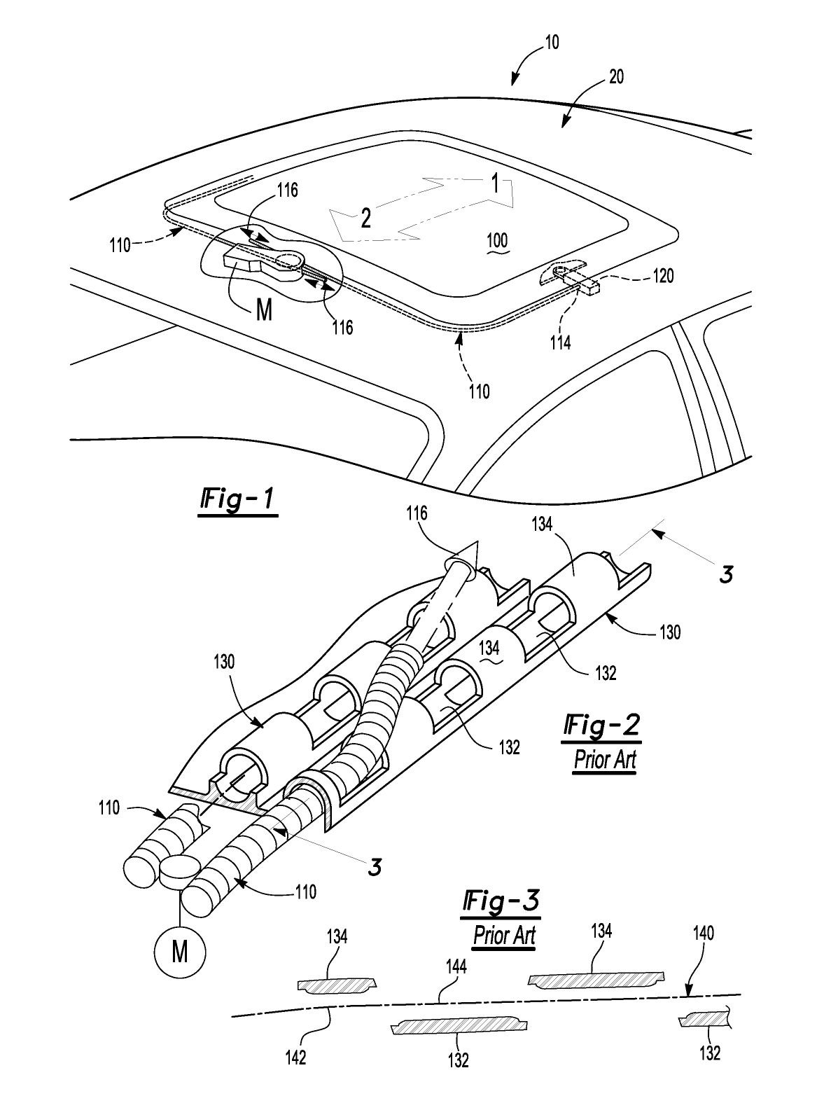

Turning now to the figures, FIG. 1 illustrates a perspective view of a motor vehicle 10 having a hard top roof 20 and a sunroof 100. The sunroof 100 can have at least one generally flexible and elongated drive element 110 that is linked to the sunroof through a mechanism 120. In addition, a motor M can be used to push and/or pull on the drive element 110 in order to afford for the sunroof 100 to move in a first direction 1 and/or a second direction 2. It is appreciated that movement of the sunroof 100 in the first direction 1 affords for opening of the sunroof while movement in the second direction 2 affords for closing of the sunroof.

The drive element 110 can have a fixed end 114 that is attached to the mechanism 120 and a free end 116 that is not attached to a component, mechanism, and the like. As the motor pushes on the drive element 110, the free element 116 moves or slides towards the motor; while when the motor pulls on the drive element 110, the free end 116 moves or slides away from the motor M.

Referring now to FIG. 2, a prior art embodiment of a guide member 130 is shown. The guide member 130 can have a plurality of alternating half-tube sections 132 and 134 that provide a tube-shaped structure for the drive element 110 to pass therethrough. FIG. 3 illustrates a cross-sectional view of the section 3-3 shown in FIG. 2 with a desired drive element path 140, the drive element 110 preferably traveling or moving along the path 140. In some instances, the desired drive element path 140 can have a first section 142 and a second section 144 that are not colinear with each other. In addition, the drive element 110 can have eccentricity along its length that can result in the free end 116 not following or traveling along the desired drive element path 140 and possibly escaping from the guide member 130 as illustrated in FIG. 2.

It is appreciated that the motor M shown in FIG. 1 can afford for the drive element 110 with the free end 116 to slide back and forth within the guide member 130. It is further appreciated that the guide member 130 can have a drive tube portion and a return tube portion in which the drive tube portion accommodates a portion of the drive element 110 that extends from the motor M to the mechanism 120 whereas the return tube portion accommodates a portion of the drive element 110 that extends from the motor M to the free end 116.

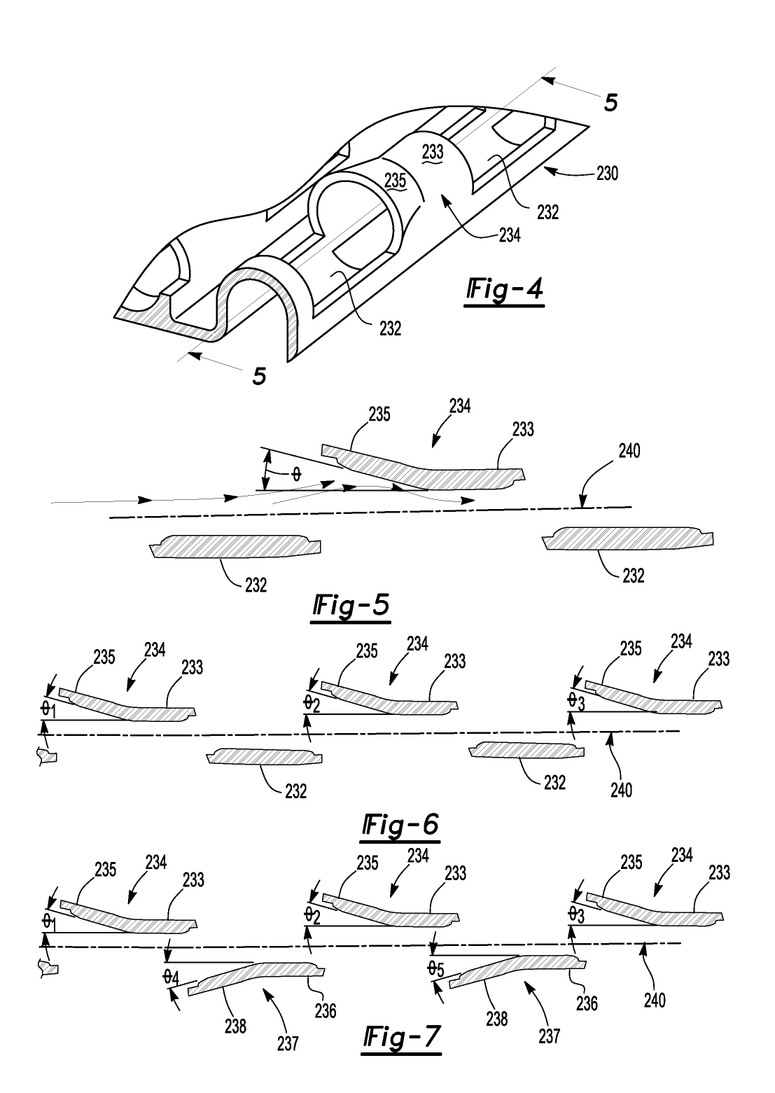

Turning now to FIG. 4, an inventive guide member 230 is shown with alternating half-tube sections 232 and 234. The section 234 can have a first portion 233 and a second portion 235. A cross section of the half-tube section 234 is shown in FIG. 5 with the second section 235 providing a funnel-shaped end for the section 234. In addition, the arrows in FIG. 5 illustrate how the funnel-shaped end 235 of the half-tube section 234 can guide the free end 116 of the drive element 110 back along a desired drive element path 240 in the event that the free end 116 deviates from the path 240 before entering the half-tube section 234. In some instances, the funnel-shaped end 235 can be offset from being generally parallel to the preferred drive element path 240 by an angle θ. The angle θ can be between 2-25°, 5-20°, 5-15° or 5-10°. In this manner, an improved guide member is provided.

In some instances, all of the half-tube sections 234 can have a funnel-shaped end 235 which is offset from being generally parallel to the desired drive element path 240 as illustrated in FIG. 6. In addition, one of the funnel-shaped ends 235 can be offset from being generally parallel to the desired drive element path 240 by an angle θ₁, another funnel-shaped end 235 can be offset by an angle θ₂, while another funnel-shaped end can be offset by an angle θ₃. In some instances, θ₁=θ₂=θ₃, while in other instances θ₁=θ₂≠θ₃. In still other instances, θ₁=θ₃≠θ₂, or in the alternative θ₁≠θ₂=θ₃. In each instance, it is appreciated that each angle can be between 2-25°, 5-20°, 5-15° or 5-10°.

The guide member 230 can further have funnel-shaped ends 231 on the half-tube sections 232 as illustrated in FIG. 7. It is appreciated that the angles θ₁-θ₅ shown in FIG. 7 can follow similar relationships as described for angles θ₁-θ₃ above. In this manner, the amount of eccentricity for a drive element that passes through the guide member 230 can be relatively large compared to prior art guide members and yet still be accommodated to travel back and forth within the plurality of half-tube sections 232 and 234.

The drive element 110 can be a cable, a belt, a chain, and the like. In some instances, the drive element 110 can be a drive cable such as the MEFLEX 614-116-022 drive cable available from Meflex Telecontrol GmbH & Co. located in Ehringshausen, Germany. The guide member can be made from any material known to those skilled in the art illustratively including metals, alloys, polymers, ceramics, and the like. In some instances, the guide member has a drive member portion and a return member portion and may or may not be an injection molded component made from a polymer such as polyethylene terephthalate (PET), polypropylene (PP), and the like. In addition, although the guide member and the plurality of half-tube sections are illustrated in the drawings as having a cylindrical shape, other elongated shapes having a cross-section of a rectangle, triangle, hexagon, polygon, ellipse and the like are included within the scope of the invention.

As such, the invention is not restricted to the illustrative examples or embodiments described above. The examples or embodiments are not intended as limitations on the scope of the invention. Processes, apparatus, compositions, and the like described herein are exemplary and not intended as limitations on the scope of the invention. Changes herein and other uses will occur to those skilled in the art. The scope of the invention is defined by the scope of the claims.

I claim:

1. A guide member for a generally flexible and elongated drive element with a free end to pass through, said guide member comprising:
a plurality of alternating half-tube sections extending along a desired drive element path, at least one of said plurality of alternating half-tube sections having a funnel-shaped end expanding an entrance of said half-tube section, said funnel-shaped end operable to guide the free end of the drive element back along the desired drive element path when the free end deviates from the desired drive element path before entering said half-tube section having said funnel-shaped end.

2. The guide member of claim 1, further comprising a drive tube portion and a return tube portion, said return tube portion having said at least one alternating half-tube section with said funnel-shaped end.

3. The guide member of claim 2, further comprising said drive element and a motor operable to push and pull said drive element through at least a portion of said plurality of alternating half-tube sections.

4. The guide member of claim 3, wherein said plurality of alternating half-tube sections, said drive element and said motor are part of a drive system.

5. The guide member of claim 4, wherein said drive system is part of a sunroof drive system.

6. The guide member of claim 5, further comprising a pair of drive tube portions and a pair of return portions, each of said return portions having at least one half-tube section with a funnel-shaped end.

7. The guide member of claim 1, wherein each of said plurality of alternating half-tube sections has a funnel-shaped end expanding an entrance of said half-tube section.

8. The guide member of claim 1, wherein said drive element is selected from a group consisting of a cable, a belt and a chain.

9. The guide member of claim 1, wherein said plurality of alternating half-tube sections and said funnel-shaped end are generally rigid.

10. The guide member of claim 9, wherein said plurality of alternating half-tube sections and said funnel-shaped end are a unitary component.

11. A drive system comprising:
a pair of generally flexible and elongated drive elements, each drive element having a drive end and a free end, said drive end linked to a panel;
a motor operable to push and pull said pair of drive elements through a pair of guide members, pushing and pulling said drive elements operable to move said panel between an open position and a closed position, said pair of guide members each having:
a plurality of alternating half-tube sections forming a tube having adjacent and oppositely disposed half open/half closed sections extending along a desired drive element path, at least one of said plurality of alternating half-tube sections having a funnel-shaped end expanding an entrance end of said half-tube section and operable to guide said free end of said drive element along said desired drive element path when said free end deviates from said desired drive element path when passing through a half-tube section immediately adjacent said half-tube section having said funnel-shaped end.

12. The drive system of claim 11, wherein each of said guide members has a drive tube portion and a return tube portion, said return tube portion having said at least one alternating half-tube section with said funnel-shaped end.

13. The drive system of claim 12, wherein all of said half-tube sections of said return tube portion has a funnel-shaped end.

14. The guide member of claim 11, wherein said drive element is selected from a group consisting of a cable, a belt and a chain.

15. The guide member of claim 11, wherein said plurality of alternating half-tube sections and said funnel-shaped end are generally rigid.

16. The guide member of claim 15, wherein said plurality of alternating half-tube sections and said funnel-shaped end are a unitary component.
